(19) United States
(12) Patent Application Publication
(10) Pub. No.: US 2014/0265003 A1
(43) Pub. Date: Sep. 18, 2014

(54) MANUFACTURING METHOD FOR STONE SPEAKER

(71) Applicants: YUN TONG ELECTRONIC (SHENZHEN) CO., LTD., Shen Zhen City (CN); BLACK CRYSTAL CRAFT TECHNOLOGY CO., LTD, Huizhou City (CN)

(72) Inventors: Stephen YU, Taipei (TW); Shu-Hsun KAO, Huizhou City (CN)

(73) Assignees: BLACK CRYSTAL CRAFT TECHNOLOGY CO., LTD, Huizhou City (CN); YUN TONG ELECTRONIC (SHENZHEN) CO., LTD., Shen Zhen City (CN)

(21) Appl. No.: 13/846,519

(22) Filed: Mar. 18, 2013

(51) Int. Cl. B29B 13/10

(52) U.S. Cl. CPC B29B 13/10
USPC 264/140

(57) ABSTRACT

A manufacturing method for a stone speaker is disclosed. The stone speaker is placed in a garden and blended with the environment. Raw stones of various sizes and colors are crashed and provided as a kind of material for the stone speaker. The manual painting spray step is neglected. The stone speakers has an appearance like real natural stone and no disadvantages of the stone speakers made by the manual painting spray step.

### BACKGROUND OF THE INVENTION

1. Field of the Invention

The present invention relates to a manufacturing method of a stone speaker, and in particular to a manufacturing method of a stone speaker without manual painting spray process.

2. Description of the Related Art

Speakers placed in a garden are often decorated to blend into environment. Typically, the decoration provides the speakers an appearance like stone which easily blends to the garden environment.

Referring to FIG. 1, a conventional stone speaker is manufactured as follows. First, talc powder and calcium carbonate powder are selected (step 1). Unsaturated polyester resin is mixed with the talc powder and calcium carbonate powder (step 2). The mixture is smeared on a surface of a prepared mold (step 3). Afterwards, glass fiber blankets are pasted layer by layer to the mold to form a blank product of the stone speaker (step 4). The blank product is bathed in a strong base solution to remove the resin (step 5). The resin-removed blank product is dried by air flow or naturally (step 6). Panting is sprayed on the blank product to form the appearance and desired color of the stone speaker which imitates natural stones (step 7).

The conventional manufacturing method of a stone speaker has the following drawbacks.

1. The manual painting spray step is necessary, which reduces the fabrication rate and also increases cost.
2. Since painting is sprayed to the blank product manually to imitate natural stone, the color of the stone speaker is obviously different from natural stones.
3. The painting sprayed manually is often peeling off due to air humidity, attached dust or liquid.
4. Since the stone speaker is placed outdoors, the painting is often aged by weather and thus chapping, fading or peeling off.
5. The painting on the stone speaker is scratched by unknown external force to reveal the blank product, which reduces the decoration effect.
6. When a metal net of larger area is installed to the speaker stone, the structure for positioning the metal net to the stone speaker is unstable, and the metal net is easily deformed by external force.

The described drawbacks causes low fabrication rate and high cost of the conventional stone speakers. The conventional stone speakers also has low yield in the factory, and painting is often peeling off.

### SUMMARY OF THE INVENTION

An object of the invention is to provide a manufacturing method for a stone speaker wherein the manual painting spray step is neglected.

Another object of the invention is to provide a manufacturing method for a stone speaker to increase capacity, reduce cost and raise yield.

Another object of the invention is to provide a manufacturing method for a stone speaker to have an appearance like real natural stone.

Another object of the invention is to provide a manufacturing method for a stone speaker to prevent chapping, fading or peeling occurred in appearance.

Another object of the invention is to provide a manufacturing method for a stone speaker to maintain the stone color even under certain external force.

Another object of the invention is to provide a manufacturing method for a stone speaker to join a large metal net by a good structure strength.

To achieve the objects, the manufacturing method for a stone speaker of the invention includes the following steps.
selecting and crashing raw stones of various sizes and colors;
mixing the crashed raw stones with unsaturated polyester resin;
smearing the mixture of the raw stones and the unsaturated polyester resin on surfaces of a mold;
pasting glass fiber blankets to the mold layer by layer with a mixture of talc power and unsaturated polyester resin to form a blank product of the stone speaker;
soaking the blank product to a strong base solution to remove unsaturated polyester resin; and
drying the resin-removed blank product naturally to form the stone speaker.

In a preferred embodiment, a metal net is integrated with the stone speaker.

### BRIEF DESCRIPTION OF THE DRAWINGS

The invention can be fully understood by reading the subsequent detailed description and examples with references made to the accompanying drawings, wherein:

FIG. 1 is a flow chart of a manufacturing method for a conventional stone speaker; and

FIG. 2 is a flow chart of a manufacturing method for a stone speaker of the invention.

### DETAILED DESCRIPTION OF THE INVENTION

The novelty and other features of the invention are described by the following embodiments accompany with the drawings.

Referring to FIG. 2, the manufacturing method for a stone speaker of the invention includes the following steps:

selecting and crashing raw stones of various sizes and colors (step 21);
mixing the crashed raw stones with unsaturated polyester resin (step 22);
smearing the mixture of the raw stones and the unsaturated polyester resin on surfaces of a mold (step 23);
pasting glass fiber blankets to the mold layer by layer with a mixture of talc power and unsaturated polyester resin to form a blank product of the stone speaker (step 24);
soaking the blank product to a strong base solution to remove unsaturated polyester resin (step 25); and
drying the resin-removed blank product naturally to form the stone speaker (step 26).

Since the stone speakers of the invention are made from crashed real stones, the tone speakers have an appearance of natural stone and the manual painting spray step can be neglected.

The manufacturing method of the invention has many advantages. No manual painting spray step is needed, and the stone speakers have a high fabrication rate, low cost and high yield. Even the stone speakers of the invention are placed outdoors for a long period, the appearance of the stone speakers are not damaged by weather. Even eternal force exerts on surfaces of the stone speakers, no chapping, fading or peeling occurs to reveal the blank product.

The manufacturing method of the invention is suitable for a metal net integrated with the stone speakers. The metal net is made with the material used for the speaker body, and the processing for the material is also applied to the metal net. The manufacturing method has the following advantages:

1. The metal net can be more blended with the appearance of the stone speaker.
2. Even a large metal net can have a stable and reliable structure.
The large metal net applied to the stone speakers has a stable structure and is not deformed by an external force.

While the invention has been described by way of example and in terms of preferred embodiments, it is to be understood that the invention is not limited thereto. To the contrary, it is intended to cover various modification and similar arrangement (as would be apparent to those skilled in the art). Therefore, the scope of the appended claims should be accorded the broadest interpretation so as to encompass all such modification and similar arrangements.

What the invention claimed is:

1. A manufacturing method of a stone speaker, comprising:
selecting and crashing raw stones of various sizes and colors;
mixing the crashed raw stones with unsaturated polyester resin;
smearing the mixture of the raw stones and the unsaturated polyester resin on surfaces of a mold;
pasting glass fiber blankets to the mold layer by layer with a mixture of talc power and unsaturated polyester resin to form a blank product of the stone speaker;
soaking the blank product to a strong base solution to remove unsaturated polyester resin; and
drying the resin-removed blank product naturally to form the stone speaker.

2. The manufacturing method as claimed in claim 1, wherein a metal net is integrated with the stone speaker.
